(19) United States
(12) Patent Application Publication
(10) Pub. No.: US 2009/0165724 A1
(43) Pub. Date: Jul. 2, 2009

(54) Teat Cup and Method for Bringing a Fluid into Contact with the Teat of an Animal

(75) Inventors: Thomas Mader, Rheda-Wiedenbrück (DE); Juan Olmedo, Oelde-Lette (DE)

Correspondence Address: SMITH LAW OFFICE, 8000 EXCELSIOR DRIVE, SUITE 301, MADISON, WI, 53717, US

(73) Assignee: WESTFALIASURGE GMBH, Boenen (DE)

(21) Appl. No.: 11/662,454

(22) PCT Filed: Sep. 13, 2005
(86) PCT No.: PCT/EP05/09805

§ 371 Date: Oct. 2, 2008

(30) Foreign Application Priority Data
Sep. 14, 2004 (DE) 10 2004 044 916.3
Mar. 15, 2005 (DE) 10 2005 012 249.3

(51) Int. Cl. A01J 7/04; A01J 5/007

(52) U.S. Cl. 119/14.02; 119/14.08

(57) ABSTRACT

Teat cup (30) and method for bringing a fluid into contact with a teat, the teat cup (30) exhibiting a housing and a teat-cup liner (32) arranged in the housing (31), said teat-cup liner separating a teat chamber from a pulsation chamber and exhibiting a head region (33), a shaft region and an end region which communicates with a milk hose. A valve is provided, with which a fluidic connection from the teat chamber to a milk hose is capable of being tightly closed. The head region (33) exhibits at least one exit region (34) which is so designed that a fluid, in particular a disinfectant, leaving the exit region (34) is directed, at least partially, radially inwards.

The invention relates to a method for bringing a fluid into contact with a teat of an animal, in particular of a cow, and also to a teat cup that is suitable for bringing a fluid into contact with a teat of an animal. Although the invention will be described in the following substantially with reference to cows, application of the invention is also suitable, in particular, in the case of sheep, goats, buffalo, llamas, camels, dromedaries, yaks and other milk-yielding animals. Semi-automatic, fully automatic or robot-controlled application is also possible, such as, for example, in an automatic robot-controlled milking system. But use in dairy farms with a conventional milking facility is preferred.

In dairy farms there is a considerable risk of the transmission of infectious agents onto and into the mammary gland. Udder diseases are therefore regarded in numerous countries with a developed dairy industry as the most significant harmful factor in animal production.

The route for infectious infiltration of the pathogens that are widespread in the environment of the milk-secreting animals is the streak canal. The transmission of the infectious agents during the withdrawal of milk and the transport thereof through the streak canal can be reduced by the prevention of a reflux of milk which is associated with the combined occurrence of cyclic and normal fluctuations in vacuum. At the conclusion of the withdrawal of milk, however, milk remains adhering to the glandular opening in the form of a drop or film, which in the case of suckler cows is removed by the calf with its tongue. In the case of dairy cows that are milked by machine, such a situation does not obtain. If this drop or film is not removed, the milk constitutes a nutrient medium for the proliferation of bacteria stemming from the environment, which consequently have the opportunity of penetrating the streak canal and of inducing an infection of the gland. The adhesion of the germs is promoted by fissures of the skin at the tip of the teat and by partial protrusions of the mucous membrane of the streak canal, so that this region may serve as a permanent reservoir of pathogens.

It is therefore an aim of prophylactic measures to keep the tip of the teat as free as possible from pathogenic agents. This can be attained by an antiseptic treatment of the teats subsequent to the withdrawal of milk. Varied methods of treatment are known. In the case of dipping, the teats are, for example, immersed in a dipping agent or sprayed therewith. In addition to the disinfecting constituents, the dipping agent may also contain grooming substances such as glycerin or lanolin. By virtue of the grooming substances, a regreasing of the teats is obtained, so that the skin of the teats remains soft and supple.

Another method of application is spraying. In this case an agent is sprayed onto the teat by a spray device. This agent may be a detergent and/or disinfectant or dipping agent. Such a method of treatment is described by WO 99/66787, by virtue of which a milking device has become known that exhibits a spray device by which an agent is sprayed onto the teat. In the lower region of the teat cup a valve is arranged by which the milk path is capable of being closed, in order to ensure that no contamination of the milk acquired by milking occurs as a result of the application of chemicals. In the course of application of the chemicals the teat is located within the teat cup, and a disinfectant is sprayed onto the tip of the teat by a spray nozzle arranged below the teat. The process has to be carried out with care, since spraying is effected in the direction of the streak canal. Spraying with high pressure may subject the streak canal of the teat to high stresses. If spraying is effected at too high a pressure, germs located in the teat chamber may get into the streak canal, which may then impair the hygiene.

Starting from here, the objective underlying the invention consists in making available a further appliance and a further method for applying a fluid onto the teat of an animal, preferably of a cow.

One aim is preferably to provide an appliance with which a simple and reliable implementation of the method is possible. But one aspect is also to ensure that a risk of contamination of the lactiferous parts with the fluid is kept as low as possible or is ruled out.

This objective is achieved, according to the invention, by a method having the features of Claim 1 and by a teat cup having the features of Claim 13. Advantageous further developments and configurations are subjects of the respective dependent claims.

According to one inventive idea, a method for bringing a fluid into contact with—and in particular for applying a fluid to—a teat of an animal, in particular of a cow, is proposed wherein at least one fluid, in particular a disinfectant, emerges through at least one exit region in an upper region of the teat cup, directed onto the teat, the milk path below the teat being closed by means of a valve, in order to prevent contamination. In particular a contamination of the further milk path is to be prevented.

By virtue of the closing of the milk path there is no risk of a contamination of the milk yield or of the milk in the tank.

Application is preferably effected, at least partially, during an operation for attaching a teat cup onto a teat of an animal or, at least partially, during an operation for removing said teat cup from a teat of an animal.

Application may also be effected while the teat is still in the teat cup, for example shortly before an operation for removing a teat cup.

By virtue of the invention there is the possibility of bringing a fluid into contact with the teat in a straightforward manner. A disinfectant, and in particular a dipping agent, is preferably applied. Application is preferably effected after a treatment of the animal, such as after milking, for example.

According to one implementation of the method, in the course of the downward motion of the teat cup in the course of removal of the same from the teat of the animal the teat of the animal is wetted with a fluid, in particular with a disinfectant. By virtue of this implementation, according to the invention, of the method it is ensured that the teat is substantially wetted completely. One advantage of the invention consists in the fact that the tip of the teat is kept free of pathogens by an appropriate agent, as a result of which a pathogenic change in the teat and in the udder can be effectively avoided.

The method according to the invention may also find application prior to a milking operation. Prior to milking, the teat of an animal is, as a rule, subjected to a cleaning operation. The cleaning liquid remains adhering to the teat, as a result of which said liquid may form a sliding film on the teat. There is therefore the possibility of the teat cup migrating upwards and pressing against Furstenberg's venous ring during the milking process. This may have the consequence that the readiness of the animal for milking diminishes. In order to avoid this, air may also be used by way of fluid to be applied, which is brought into contact with the teat during an attachment operation. A drying of the teat is obtained by this means. As a result of the drying of the teat, the sliding film is eliminated, and the risk of the teat cup or milking cup climbing upwards is considerably reduced.

Preferably at least one exit region for a fluid is arranged in the head region of the teat cup. It is preferred that at least one exit region is arranged on the inner edge of the teat cup. An exit region is preferably provided in the inner head region, so that the agent is applied onto the teat from the side.

In the course of execution of the method preferably at least one exit region is arranged along or on the upper and/or outer edge of the teat cup. Before milking the teat maybe cleaned by supplying of at least one cleaning fluid or at least one cleaning liquid through one or several exit regions. Thereby or later on the teat maybe stimulated at the same time by directed supply of fluids. As an example the teat maybe dried and simultaneously stimulated by directed supply of air.

With such a configuration, according to another implementation of the method a certain amount of disinfectant can be applied on the outer surface of the teat cup for the purpose of wetting the edge of the teat prior to removal of the teat cup. This can be effected, for example, by virtue of exit apertures arranged along the upper edge of the teat cup, so that the fluid that has emerged collects around the teat on the upper edge of the teat cup. If a vacuum still prevails in the teat cup, then by virtue of the difference in air pressure from the environment to the teat chamber the fluid is sucked through leaks and is introduced into the teat cup. Due to the force of gravity, the fluid flows downwards along the teat and distributes itself on the surface of the teat.

The introduction and distribution of the fluid may also be assisted by a movement of the teat-cup liner. To this end, the pulsation, for example, may be turned on, and an alternating vacuum with a frequency of, for example, between 45 and 75 per minute may be applied to the pulsation chamber. A higher frequency of, for example, between 150 and 400 per minute is preferred. A frequency of approximately 300 cycles per minute may, for example, be suitable, as is used in the course of stimulation. The magnitude of the vacuum may also be reduced in comparison with the pulsation-chamber vacuum in the course of milking, in order, for example, to achieve a massaging-in and a good distribution of the fluid. By virtue of the vibrating motion, the teat as a whole is wetted in this way.

According to an advantageous further development of the method, it is proposed that the volumetric flow rate of the at least one fluid is varied as a function of the length of the teat and/or as a function of the progress of the attachment or removal. In this connection an adaptation of the volumetric flow rate to the speed at which the teat cup is attached onto the teat or removed from the teat may be effected.

Wetting of the teat with at least one fluid is preferably effected by spraying at least one fluid.

If, for example, firstly a sufficiently large amount of fluid is brought onto the teat at the start of the removal operation, the fluid flows—if the fluid in question is a liquid—downwards in the direction of the tip of the teat.

The volumetric flow rate may be reduced in an appropriate manner.

The fluid may also emerge at a time close to the start of the removal operation, so that the transition region between the teat and the udder of the animal is also wetted by the fluid.

Two, three or more different fluids may also be sprayed. Preferably at least two fluids are conveyed through different exit regions. The two fluids may be liquids that develop their activity only when they come together to prevent that upon supply of the dipping agent an aging of the dipping agents occurs in the dipping agent line.

Use is preferably made of at least one dipping agent. In addition to this, or instead of it, use may also be made of at least one grooming agent.

After application of a disinfectant or dipping agent or grooming agent, the teat cup is preferably cleaned, rinsed and/or disinfected. Disinfection of the teat cup may also be effected after each milking operation and an appropriate supply of e.g. water for rinsing. The inlet or the inlets may also be used for an intermediate disinfection and/or and intermediate rinsing between two or more milking operations.

The teat cup is preferably rinsed from the valve, by an appropriate inlet for a rinsing agent and/or disinfectant being provided in the valve.

The teat cup according to the invention comprises a housing and a teat-cup liner arranged in the housing, which separates a teat chamber from a pulsation chamber and which exhibits a head region, a shaft region and an end region which communicates with a milk hose, a valve being provided with which a fluidic connection from the teat chamber to the milk hose is capable of being closed. The head region exhibits at least one exit region which is so designed that a fluid, in particular a disinfectant, leaving the exit region is orientated, at least partially, radially inwards.

This means that the fluid is orientated in the direction of a central axis or a central region of the teat cup, or that the emerging fluid has a radial component.

For example, a concentric arrangement of several exit regions may be present. Individual exit regions or all exit regions may also have a tangential component in addition to a radial component.

In a manner departing from the known state of the art as described in WO 99/66787, the fluid is not sprayed onto the tip of the teat from below. The fluid runs down the teat and wets the teat. By virtue of this measure, formation of a drop of fluid on the glandular opening is achieved. The streak canal is wetted and sealed in an outstanding manner, so that the risk of a pathogenic situation on the teat is reduced to a considerable degree.

The fluid leaving the exit region preferably emerges, at least partially, also in the direction of a longitudinal axis of the teat cup. The outflow direction of the fluid is therefore given an axial component.

In advantageous manner at least one exit region is arranged on the inside of the teat-cup liner.

The at least one exit region is preferably arranged in the head region of the teat-cup liner in such a way that this exit region lies outside a teat-receiving chamber bounded by the teat-cup liner. By virtue of this measure, the possibility is also created of cleaning the exit region without the fluid getting into the teat chamber. Said fluid may be arranged on the inside in the head chamber or at the top on the teat-cup liner.

The head region preferably exhibits a plurality of exit regions. The arrangements of the exit regions are chosen so that a complete wetting of the teat with the fluid is possible or, for example, is effected by subsequent self-distribution.

In particular, it is proposed that several exit regions are provided, arranged equidistantly from one another on an imaginary circumference of the head region. By virtue of this measure, a relatively uniform distribution of the fluid over the circumference can be achieved if the exit regions are similarly configured. The advantage of the several exit regions arranged equidistantly from one another on an imaginary circumference of the head region also consists in the fact that the production of the teat-cup liner is simplified, since the latter is, in particular, of symmetrical design, preferably of rotationally symmetrical design.

A configuration of a teat-cup liner is preferred in which several exit regions are provided, offset relative to one another along the circumference and in the axial direction of the teat-cup liner. A further, improved wetting of a teat is achieved by this means.

For an effective wetting of the teat and also for a reduction in the consumption of the fluid, it is proposed that at least one exit region takes the form of a nozzle. In particular, it is proposed that the exit region is designed in the form of a spray nozzle. The spray angle, or the spray lobe of the individual exit regions, may be variable. If the teat-cup liner exhibits a plurality of exit regions, individual exit regions or groups of exit regions may be designed with different spray nozzles, so that the spray effect can be influenced to a positive degree. There is also the possibility of bringing about differing spray patterns by variations in the exit regions.

According to yet another advantageous design of the teat-cup liner, it is proposed that at least one duct extending over at least a part of the circumference of the head region is provided which exhibits at least one exit region. By virtue of this measure, the fluid conveyed into the duct is able to emerge via several exit regions. The duct may be provided in a separate component which, for example, is made of metal.

According to yet another advantageous configuration of the teat-cup liner, it is proposed that the exit region is formed on a front side of a duct extending substantially in the axial direction of the teat-cup liner. By virtue of this measure, each exit region can be supplied with a fluid via a separate duct. Therefore there is the possibility of making differing fluids emerge through different exit regions. In this connection it may be a question, for example, of two different liquids which develop their desired property only as a result of coming together.

The supply of the duct or ducts is preferably effected via at least one supply duct. The supply duct may be formed on the teat-cup liner itself. There is the possibility of, for example, two supply ducts being provided, with one supply duct serving as a reserve duct which comes into operation when the other supply duct becomes inoperative.

According to yet another advantageous configuration of the teat-cup liner, it is proposed that at least two supply ducts are provided, through which differing fluids are capable of being supplied to the exit regions independently of one another.

By virtue of this measure, during an operation for attaching a teat cup according to the invention with the teat-cup liner there is, for example, the possibility of air, for example, being conveyed through the supply duct to the exit regions, as a result of which a cleaning action and, where appropriate, a drying action are achieved. Particles can be blown away from the teat by the air flowing against the teat.

If prior to the milking operation the teat or the udder of an animal has been subjected to a cleaning operation in the course of which a liquid still adheres to the teat, then by virtue of the air flowing out of the exit regions a drying of the liquid can be achieved, so that the liquid does not get into the teat-cup liner, an occurrence which may result in a possible contamination of the milk yield.

With a view to simplifying the production of the teat-cup liner, it is proposed that the teat-cup liner is of bipartite design.

According to yet another advantageous configuration of the teat-cup liner, the exit regions and/or the ducts are located in and/or on the head region of the teat-cup liner. The ducts may be moulded on. However, there is the possibility of the ducts being formed in situ during the process for producing the teat-cup liner. The teat-cup liner preferably consists of an elastomeric material.

According to another inventive idea, an attachment for use with a teat-cup liner and/or with a teat cup is proposed, the teat cup exhibiting at least one valve for shutting off the milk path. The attachment is of tubular design. In the region of a front face it exhibits at least one exit region which is so designed that a fluid, in particular a disinfectant, leaving the exit region emerges, at least partially, in the direction of a longitudinal axis of the teat-cup liner.

The attachment according to the invention opens up the possibility of retrofitting existing teat-cup liners or teat cups with a shut-off valve in such a way that a treatment of the teat with a fluid is made possible, whereby at the same time the quality of the milk acquired by milking is not jeopardised by the disinfectant, since penetration into the milk path is reliably prevented. The retrofitting of the teat-cup liner or of a teat cup is effected in this case in such a manner that the attachment is placed over the teat-cup liner or the teat cup. By virtue of the fact that the attachment is of tubular design, the opening in the head of the teat-cup liner remains free, so that the functionality of the teat-cup liner or of the teat cup is retained. The attachment is so adapted to the teat-cup liner or to the teat cup that a lip of the head of the teat-cup liner remains unchanged by the attachment with regard to its flexibility.

A configuration of an attachment is preferred in which several exit regions are provided, arranged equidistantly from one another in the circumferential direction. The exit regions may also be formed not only distributed over the circumference but also offset relative to one another in the axial direction of the attachment.

In order to achieve a spray effect, at least one exit region of the attachment is designed in the form of a nozzle, preferably in the form of a spray nozzle. There is also the possibility of spray nozzles being inserted into the exit regions in the form of separate components. This possibility exists not only in the case of the attachment but also in the case of the teat-cup liner according to the invention.

The supply of the at least one exit region with a fluid may be effected via a virtually annular duct, i.e. a duct that extends at least over a part of the circumference of the attachment. If several exit regions are provided, it is advantageous if each exit region is supplied with a fluid via a separate duct. The annular duct arranged in a separate component may be employed as a separate part also for the retrofitting of conventional teat-cup liners if the separate component is introduced in the form of an insert and if the feed lines are preferably supplied from outside and attached in the head region.

The individual ducts of the exit regions may be connected to at least one supply duct.

Depending on the structural design of the teat-cup liner or of the teat cup, it may be advantageous if the attachment is of bipartite construction, in order in this way to facilitate the fitting of the attachment to the teat-cup liner or to the teat cup.

The exit regions and/or the ducts are preferably formed in and/or on a wall of the attachment. The attachment preferably consists of a plastic, in particular an elastomeric plastic.

In order to obtain a secure connection of the attachment to a teat-cup liner and/or to a teat cup, according to another advantageous configuration of the attachment it is proposed that the latter exhibits means for positive or frictional connection in the teat-cup liner and/or in a teat cup.

The connection of the attachment to the teat-cup liner and/or to a teat cup is preferably a connection of detachable design, so that the possibility is created, for example, of exchanging the teat-cup liner if the latter is worn.

The housing of the teat cup according to the invention preferably exhibits at least one connecting duct which is connected to at least one duct and/or supply duct and communicates with at least one fluid source. In particular, it is proposed that the connecting duct exhibits an adapter which projects into the duct or into the supply duct. By virtue of this measure, a connection between the connecting duct and the duct or the supply duct is created by simple means. The cross-sections of the connecting duct and of the adapter are of such dimensions that a fluid-tight connection arises.

According to yet another advantageous configuration of the teat cup, it is proposed that the latter is connected to a hose which exhibits at least two conduits, at least one of the conduits being connected to the at least one connecting duct. In this case a configuration of a hose is preferred in which a conduit is connected to the end region of the teat-cup liner and a further duct is connected to a pulse-vacuum adapter. The hose exhibiting three conduits serves for the drainage of the milk acquired by milking, for the supply of the pulsation chamber with varying subatmospheric pressure, and also for the supply of the exit regions with a fluid. The conduits within the hose may have differing cross-sectional shapes. Given an appropriate configuration of the connecting pieces, the possibility of confusing the connectors is reduced by this means.

If the teat cup according to the invention exhibits an attachment, it is advantageous if the teat cup and the attachment exhibit means for positive or frictional connection. In particular, it is proposed that a latching connection is formed between the teat cup and the attachment.

According to another inventive variant of the method, it is proposed that at least one teat cup is attached onto a teat of the animal. The attachment operation is directly followed by a milking operation. Once the milking operation is regarded as having been concluded, a signal is generated. A removal of the teat cup takes place if the signal was generated, whereby at least during the removal of the teat cup at least one fluid emerges onto the teat above the head region through at least one exit region provided in the head region of a teat-cup liner. The exit region may be formed in the teat-cup liner itself and/or in an attachment such as described above.

The teat cup may comprise a combination of the teat-cup liner according to the invention and of the attachment according to the invention. By virtue of this inventive combination, a variation of the exit regions as regards their number and configuration can be achieved.

In all the configurations previously described the teat cup may comprise a multi-way valve. In particular, the valve for closing the milk path of the teat cup may be constructed in the form of a multi-way valve. By means of the valve, the milk path is capable of being closed from the teat cup, in order to prevent a contamination of the milk by the dipping agent.

The valve is preferably arranged in a lower region, in particular in the end region of the teat cup or in the milk hose. In advantageous manner the valve comprises at least one spray nozzle. In particularly preferred manner, the spray nozzle of the valve in the closed position is in the operating position. The valve preferably exhibits an outlet which is active in the operating position and through which fluid that has run down is able to flow out of the teat cup to the outside.

Furthermore, differing drainage lines may be provided on the valve. For example, in addition to the line for the main milk yield, a drainage line for the foremilk may also be provided which, for example, leads to a sensor for examining the foremilk, which examines the foremilk for flakes or examines the cell-count or other parameters. A drainage line for “bad milk” may also be provided, through which unusable milk is drained away directly. One or more drainage lines for milk of differing quality may also be provided, for example for milk having a particularly high solids content etc., in order to collect milk of various grades in different containers.

The valve is preferably arranged at the transition from the teat-cup liner to the short milk hose, or in the inspection glass. A supply line may be provided on the valve or on the multi-way valve, in order to apply a disinfectant and/or a dipping agent and/or a grooming agent and/or a teat care or skin care agent onto the teat from below. In addition to this line, or instead of it, a line for supplying a cleaning fluid may also be provided, by means of which rinsing water, for example, is capable of being supplied after the milking unit has been removed, in order to rinse out residues and remove them reliably. Water or such like can be supplied through such a line also after an intermediate disinfection.

The valve or a valve for closing of the milk path can also be provided in the long milk hose and/or in or at the claw piece and/or in the long milk hose.

In the teat cup, or immediately adjacent to it, for example in the short or long milk hose, a sensor device or several sensor devices may be provided. The temperature and the conductivity of the milk, for example, can be determined therewith. Hence a characteristic measure of, for example, the temperature and/or the conductance or conductivity can be ascertained. In addition, a milk-flow sensor may be integrated or may be present separately. Moreover, a pressure sensor may be provided. A tilt sensor may also be arranged on the teat cup, which, for example, emits a signal when a teat cup falls off. In addition, a teat sensor which detects the presence of a teat may be provided on the teat cup. The sensor may be constructed in the form of a capacitive sensor, an inductive sensor or a sensor of some other type. The signals are used for the purpose of controlling the procedure.

At least one combined sensor device is preferably provided, by means of which at least a temperature and a measure of the conductivity of the milk are capable of being determined.

The individual sensors or the sensor device may be connected to a control device in wire-bound or even wireless manner. To this end, a signal-transmission device for the wireless transmission of signals is preferably provided. It is possible for a sensor to comprise a battery or some other type of energy storage device. Also possible is the use of RFID technology, in which case elements having a rewritable memory are then employed. A supply of energy may then also be effected through the read-out panel. Overall, the structure may be modular.

Further particulars and advantages of the invention will be elucidated on the basis of the exemplary embodiments represented in the drawing, without the subject-matter of the application being restricted to these concrete exemplary embodiments.

Shown in the Figures are:

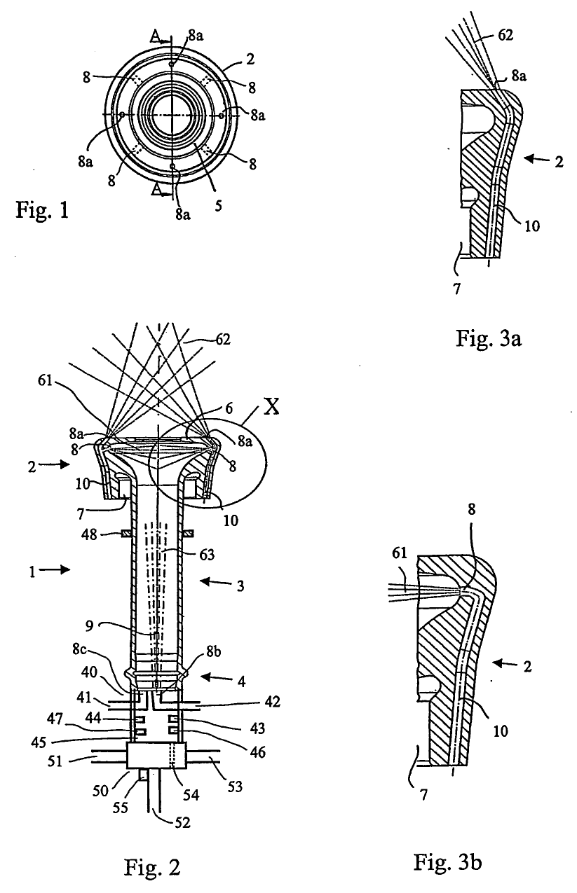

FIG. 1 a first exemplary embodiment of a teat-cup liner according to the invention, in a top view,

FIG. 2 the teat-cup liner according to FIG. 1 in a section along section line A-A according to FIG. 1,

FIG. 3a on an enlarged scale, a detail X of the head region of the teat-cup liner,

FIG. 3b on an enlarged scale, a further detail X of the head region of the teat-cup liner,

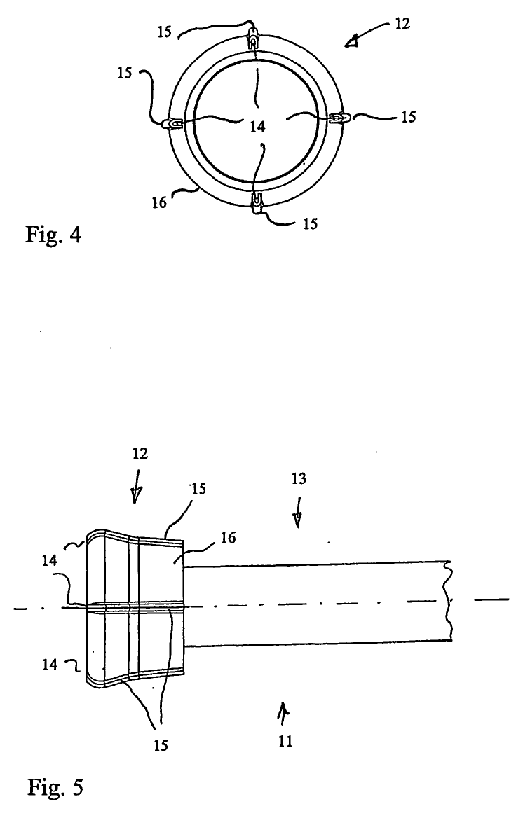

FIG. 4 a second exemplary embodiment of a teat-cup liner, in a top view,

FIG. 5 a side view of the second exemplary embodiment of the teat-cup liner,

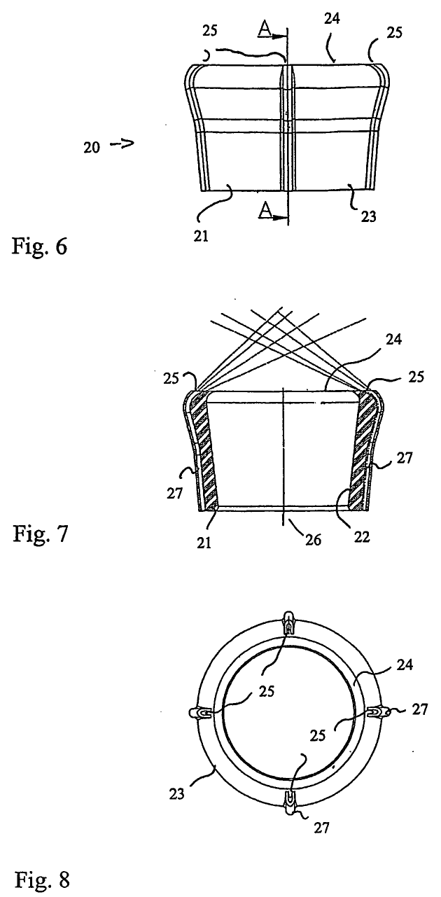

FIG. 6 an exemplary embodiment of an attachment, in a side view,

FIG. 7 the attachment in a sectional view along section line A-A according to FIG. 6,

FIG. 8 the attachment in a top view,

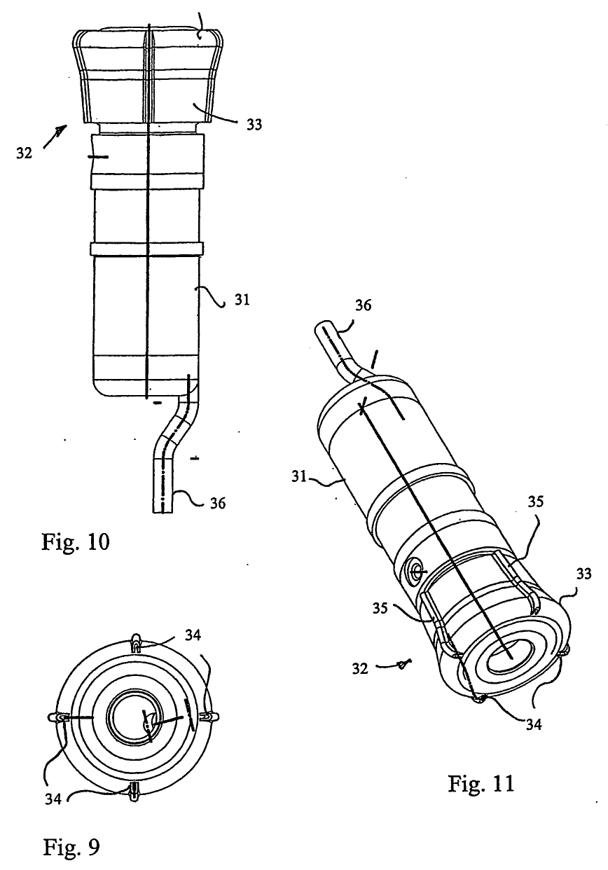

FIG. 9 a teat cup in a side view,

FIG. 10 the teat cup in a side view, and

FIG. 11 the teat cup in a perspective view.

In FIGS. 1, 2 and 3 a first exemplary embodiment of a teat cup according to the invention is represented in highly schematic manner. The teat-cup liner 1 of the teat cup 30 exhibits a head region 2. The housing 31 of the teat cup 30 is not illustrated here in FIGS. 1, 2 and 3, but is illustrated in FIG. 11. The head region 2 of the teat-cup liner 1 is adjoined by a shaft region 3 which merges with an end region 4. The end region 4 is so configured that the latter is capable of being connected to the housing 31 of the teat cup 30.

The end region 4 is of open design in the downward direction, in order to transport away the milk acquired by milking. For the purpose of transporting the milk yield away, the end region 4 is fluidically connected to a milk hose in a milking facility. The end region 4 of the teat-cup liner is adjoined in the teat cup 30 by a valve 40 which here, in this exemplary embodiment, takes the form of a multi-way valve 50 or comprises such a valve. By means of the valve, the milk path is closed if dipping agent is being applied onto the teat, in order to prevent a contamination of the milk acquired by milking. A tight closure of the milk path in the course of the dipping of a teat is an essential aspect of the structural design of the teat cup, in order to securely prevent a contamination of the milk yield.

The head region 2 exhibits an aperture 5, through which a teat of an animal (not represented) is capable of being introduced into the teat cup or into the teat-cup liner. The aperture 5 is bounded by a lip 6. The lip 6 is flexible, so that it presses closely against the surface of a teat. The section of the head region 2 situated opposite the aperture 5 is of double-walled design with an annular groove 7 opening towards the end region 4. An upper end region of the housing 31 of the teat cup 30 projects into the annular groove 7.

In the exemplary embodiment that is represented, the teat cup comprises four different types of exit region 8, 8a, 8b and 8c. The three exit-region types 8a, 8b and 8c each serve for the application of fluid, in particular of disinfectant, dipping agent and/or grooming agent, onto the teat. By virtue of the exit region 8c, the teat cup or even the teat can be rinsed, in order to clean the teat prior to milking or to rinse the teat cup after milking.

In the exemplary embodiment that is represented, the head region 2 exhibits four exit regions 8 and four exit regions 8a. The exit regions 8 and 8a are each so designed that a fluid, in particular a disinfectant, leaving the exit region 8 or 8a emerges, at least partially, orientated radially inwards. In FIG. 2 the fluid emerging from the exit regions 8 is represented schematically by dashed lines 61, and the fluid emerging from the exit regions 8a is represented schematically by dashed lines 62.

The fluid emerges from the exit regions 8 substantially only in one plane; axial components of the direction of flow in the direction in which the teat cup extends are present only to a small degree. The teat in the teat cup is sprayed directly with the dipping agent. The dipping agent runs down the teat. By virtue of an appropriate number of exit regions 8 or exit apertures it is ensured that the teat as a whole is reliably wetted. With a view to assisting the distribution of the dipping agent, the pulsation can be turned on, in order to make the teat-cup liner exert a massaging action on the teat. In this connection a high frequency, such as is otherwise chosen at the start of milking in the course of stimulation, is preferably adjusted. The pulsation vacuum for distributing the dipping agent is likewise chosen to be lower than the pulse vacuum in the course of milking. The pulse vacuum is preferably chosen so that the teat-cup liner rests substantially in close contact with the teat for the entire time and does not lift away, or lifts away only slightly. The exit regions 8a, on the other hand, are each so designed that a fluid leaving the exit regions 8a emerges not only directed inwards in the radial direction but also directed axially upwards in the direction of the udder. By means of the exit regions 8a, dipping agent is sprayed onto the teat which is arranged above the teat cup. The dipping agent will run down the outside of the teat and will collect on the upper side of the teat-cup liner if the teat is still in the teat cup. By virtue of the difference in pressure and by virtue of imperfectly sealed contiguity of the teat-cup liner with the teat, the dipping agent gets into the interior space and distributes itself on the teat. The distribution can be assisted by a movement of the teat-cup liner, as described in the previous paragraph.

But dipping agent can also be sprayed with the exit regions 8a precisely when the vacuum is turned off and the removal of the teat cup is being undertaken. Given choice of a suitable time, in the course of removal the teat is sprayed over its entire outer surface, particularly if dipping agent is being sprayed at the same time from the interior exit regions 8.

In the example that is represented, the exit regions 8 and 8a are arranged equidistantly from one another, in each instance on an imaginary circumference of the head region. The exit regions 8 and 8a are preferably designed in the form of spray nozzles.

With a view to supplying the fluid to the individual exit regions 8 and 8a, ducts 10 are formed in the head region 2. One duct 10 is assigned in each instance to each exit region 8 and 8a. The ducts 10 extend substantially in the axial direction of the head region 2 or of the teat-cup liner, as is evident from FIGS. 2, 3a and 3b. By virtue of the fact that the exit regions are connected to individual ducts, differing fluids can be supplied to individual or several exit regions 8 and 8a.

The configuration of the teat-cup liner according to the invention, as represented in FIGS. 3a and 3b, shows that the ducts are formed in the head region 2. The exit regions 8 with the associated ducts 10 may also be formed on a separate component which is inserted into the teat-cup liner 1 or into the teat cup 30.

The exit region 8b is provided on the multi-way valve 50, which here is represented only schematically in FIG. 2. Through the supply line 42 a dipping agent or grooming agent or a disinfectant can be supplied to the interior space of the teat cup. The rays 63 show schematically how the fluid enters the teat cup. In addition to one or both exit regions 8 and 8a, the exit region 8b may be used in order to bring fluid into contact with a teat. In this connection the same dipping agent may be output from each of the exit regions 8, 8a and 8b.

Differing dipping agents may be brought into the interior of the teat cup from the various types of exit region, in order to take account of the differing positions in relation to the teat.

In other implementations of the method, dipping agent is applied only from the exit regions 8 or 8a, whereas after dipping and removal of the teat cup have taken place the teat cup is disinfected by a disinfectant being output from the exit region 8b into the interior space of the teat cup. Then rinsing water can then be conveyed into the teat cup through for example the exit region 8c (or another).

But it is also possible that a disinfectant for disinfecting the teat cup is firstly conveyed via the supply line 41 of the exit region 8c, and that rinsing water is subsequently conducted through the supply line 41.

There is the possibility of several ducts being connected to at least one supply duct.

In the teat cup, or in the adjoining hose, various sensors may be provided, the sensor signals of which are capable of being transmitted in wireless or wire-bound manner by means of a signal-transmission device 55.

In the current exemplary embodiment a flow sensor 43 is present which serves for determining the flow of milk. Depending on the accuracy of the result of measurement, the milking process as a whole can be controlled. A sensor of temperature and conductivity 44 serves for registering the temperature of the milk and the conductance, in order to ascertain the conductivity of the milk therefrom. Both parameters can be used for an estimation of the health status. In order to avoid dry milking, a milk-flow sensor 43 is provided. A pressure sensor 47 serves for examining the vacuum, the signals of which can be used, for example, in order to detect a teat that has kinked in the milking cup.

A tilt sensor 46, such as is known in the state of the art, serves for monitoring the position of the teat cup 30. As from a certain inclination a warning signal is output, since the teat cup may have fallen off or been knocked off. As a result of this warning signal the teat cup can be separated from the vacuum supply by closing of the respective valve.

By means of a capacitive teat sensor 48 a check is made prior to the start of milking as to whether the teat is in the teat cup; otherwise a signal is output. Moreover, the teat sensor 48 is employed in order to check prior to application of the dipping agent whether the teat is still in the teat cup. Prior to an operation for rinsing or disinfecting the teat cup, the presence of a teat is likewise firstly checked, whereby, however, in these cases a rinsing or a disinfection when a teat is present does not happen, since, in particular, the disinfectant for the teat cup is not suitable for direct contact with the teat or has to be provided for this purpose.

A further sensor (not shown) maybe provided for checking whether the milk path is blocked. With the help of the sensor it can be guaranteed that no chemicals or the like enter into the milk path or the milk tank, respectively.

In the course of milking, with the multi-way valve 50 the foremilk can be drained away into a line 51 for the foremilk, which leads to a sensor (not represented) for examining the foremilk, for flocks for example. The main milk is drained away into the line 52 for good milk, unless the control system brings about a separation of the milk yield into a line 53 for bad milk. This can happen on the basis of measured data, or alternatively if the animal is, for example, being treated medicinally and the milk has to be discarded. It is also possible that various lines for differing qualities of milk are present, in order to drain away milk of particularly high quality, or having a particularly high solids content, into a special tank.

When the milk path is closed by the valve 40 or 50, a drainage duct 54 can be opened which is in communication with the environment or with a special drain or with the line for bad milk. Residues of dipping agent that have run down in the course of dipping can then drain away unhindered through the drainage duct 54.

FIGS. 4 and 5 show a second exemplary embodiment of a teat-cup liner for the teat cup according to the invention. The teat-cup liner 11 exhibits a head region 12 which merges with a shaft region 13. It also exhibits an end region 5 which is not represented. The basic structure of the teat-cup liner 11 corresponds to the structure of the exemplary embodiment of a teat-cup liner represented in FIGS. 1, 2 and 3a and 3b.

As is evident from FIG. 4 and FIG. 5, the head region 12 exhibits four exit regions 14 which are each offset relative to one another by 90 degrees. The exit regions 14 are connected to ducts 15. In the exemplary embodiment that is represented, the ducts 15 are formed on the surface 16 of the head region 12. They may be attached onto the head region 12 by injection moulding. Moreover, interior exit regions 8 may also be provided, which enable a spraying of the teat in the head chamber.

In FIGS. 6, 7 and 8 an attachment for use with a teat-cup liner or with a teat cup is represented. The attachment 20 exhibits a body 21. The body 21 is of substantially tubular design. It exhibits an inner shell 22 which is capable of being brought into abutment with the surface of a teat cup. To this end, the attachment is pushed over an anterior end section of the teat cup or over the head region of a teat-cup liner. The inner shell 22 of the attachment 20 may exhibit means for positive or frictional connection to a teat-cup liner or to a teat cup. The means are preferably latching means. For the purpose of exchanging the attachment or a teat-cup liner from a teat cup, the connection between the attachment and the teat-cup liner, or between the attachment and the teat cup, is designed to be detachable.

In the region of a front face 24 the attachment 20 exhibits exit regions 25 which are so designed that a fluid, in particular a disinfectant, leaving the exit region 25 emerges, at least partially, in the radial direction and partially in the direction of a longitudinal axis 26 and above the front face 24. The fluid emerging from the exit regions 25 is represented schematically in FIG. 7 by the dashed line. The supply of the fluid to the exit regions 25 is effected via ducts 27 which extend substantially in the axial direction of the attachment. In the exemplary embodiment that is represented, the ducts 27 are formed on a wall 23 of the attachment. This is not strictly necessary. There is also the possibility of the ducts being integrated within the wall 23. The attachment 20 is preferably manufactured from an elastic material, in particular from an elastomeric plastic.

A teat cup 30 is represented in FIGS. 9 to 11. The teat cup 30 exhibits a housing 31. The housing 31 is of substantially cylindrical design. The teat cup furthermore exhibits a teat-cup liner 32 which exhibits a head region 33. The head region 33 is adjoined by a shaft region which projects into the housing 31. A valve 40 or a multi-way valve 50 is provided for the purpose of closing the milk path. The end region of the teat-cup liner communicates with a milk hose which is not represented.

In the exemplary embodiment that is represented, the head region 33 exhibits exit regions 34. The exit regions 34 are formed in such a way that a fluid, in particular a disinfectant or a dipping agent, leaving the exit region 34 emerges, at least partially, radially inwards and also in the direction of a longitudinal axis and above the head region 33.

The supply of a fluid is effected via ducts 35. The ducts 35 may be connected to hoses which are not represented, through which a fluid is transported from a fluid source to the exit regions. There is also the possibility of a hose being provided which exhibits several conduits. This hose exhibits, for example, a conduit which is capable of being connected to the end region of the teat-cup liner and which serves for transporting the milk. A further conduit may be connected to a pulse-vacuum adapter 36. A further conduit serves for supplying the exit regions with a fluid.

Alternatively, there is also the possibility of supply ducts being formed in the housing itself. Said supply ducts may, for example, be integrated within the wall of the housing.

By virtue of the invention there is the possibility of bringing a fluid into contact with the teat. If, for example, air by way of fluid is brought into contact with the teat during an attachment operation, a drying of the teat is obtained. Prior to milking, the teat of an animal maybe cleaned. The cleaning liquid remains adhering to the teat, as a result of which said liquid may form a sliding film. As a result of this, the teat cup might migrate upwards during the milking process and press against Furstenberg's venous ring, as a result of which, inter alia, the readiness of the animal for milking may diminish. By virtue of the drying of the teat prior to milking, the sliding film is eliminated.

In all configurations the exit regions 8a and 8b etc. may be connected to one another or may be separated from one another. Simultaneous or alternating operation is then possible.

By a pulsating air and water flow before the beginning of the main milking phase the teat maybe stimulated, so that if applicable a separate stimulating phase maybe waived, especially when with the teat cup according to the invention cleaning and foremilking also takes place.

In all cases the fluid or the fluids can be brought to the individual exit regions by one or more pumps. The use of pressurized air is also possible to drive out the fluids. Thereby the produced velocity of the exiting fluids may vary according to the arrangement of the exit region and/or type of the fluid. As an example a lower pressure maybe used when spraying from below compared to spraying from the side. By the lower pressure a lower exit velocity is produced.

### LIST OF REFERENCE SYMBOLS

1 teat-cup liner
2 head region
3 shaft region
4 end region
5 aperture
6 lip
7 annular groove
8, 8a, 8b exit region
9 longitudinal axis
10 duct
11 teat-cup liner
12 head region
13 shaft region
14 exit region
15 duct
16 surface
20 attachment
21 body
22 inner shell
23 wall
24 front face
25 exit region
26 longitudinal axis
27 duct
30 teat cup
31 housing
32 teat-cup liner
33 head region
34 exit region
35 duct
36 pulse-vacuum adapter
40 valve
41 supply line
42 supply line
43 flow sensor
44 temperature and conductance sensor
45 drainage line
46 tilt sensor
47 pressure sensor
48 teat sensor
50 multi-way valve
51 line for the foremilk
52 line for good milk
53 line for bad milk
54 drain
55 signal-transmission device
61 lines
62 lines
63 rays

1. A method for bringing a fluid into contact with a teat of an animal, in particular of a cow, wherein at least one fluid, in particular a disinfectant, emerges through at least one exit region in an upper region of the teat cup, directed onto the teat, the milk path below the teat being tightly closed by means of a valve, in order to prevent contamination.

2. The method according to claim 1, wherein at least one exit region is arranged in the head region of the teat cup.

3. The method according to claim 1, wherein at least one exit region is arranged on the inner edge of the teat cup.

4. The method according to claim 1, wherein at least one exit region is arranged on the upper and/or outer edge of the teat cup.

5. The method according to claim 1, wherein the volumetric flow rate of the at least one fluid is varied as a function of the length of the teat and/or as a function of the progress of attachment or removal.

6. The method according to claim 1, wherein at least one fluid is sprayed.

7. The method according to claim 1, wherein at least two fluids are sprayed.

8. The method according to claim 1, wherein at least two fluids are conveyed through differing exit regions.

9. The method according to claim 1, wherein use is made of at least one dipping agent.

10. The method according to claim 1, wherein use is made of at least one grooming agent.

11. The method according to claim 1, wherein the teat cup is subsequently rinsed and/or disinfected, wherein the teat cup is particularly rinsed from the valve.

12. The method according to claim 1, wherein the valve is arranged in the teat cup and/or in the short milk hose and/or in the long milk hose.

13. A teat cup with a housing and with a teat-cup liner arranged in the housing, said teat-cup liner separating a teat chamber from a pulsation chamber and comprising a head region, a shaft region and an end region which communicates with a milk hose, a valve being provided with which a fluidic connection from the teat chamber to the milk hose is capable of being closed, and the head region exhibiting at least one exit region which is so designed that a fluid, in particular a disinfectant, leaving the exit region is directed, at least partially, radially inwards.

14. The teat cup according to claim 13, characterised in that the fluid leaving the exit region emerges, at least partially, in the direction of a longitudinal axis of the teat cup.

15. The teat cup according to claim 13, characterised in that at least one exit region is arranged on the inside of the teat-cup liner.

16. The teat cup according to claim 13, characterised by a teat-cup liner with several exit regions arranged equidistantly from one another on an imaginary circumference of the head region.

17. The teat cup according to claim 13, characterised by a teat-cup liner that exhibits several exit regions offset relative to one another along the circumference and in the axial direction of the teat-cup liner.

18. The teat cup according to claim 13, characterised by at least one exit region taking the form of a nozzle which, in particular, is designed in the form of a spray nozzle.

19. The teat cup according to claim 13, characterised in that on the teat-cup liner at least one duct extending over at least a part of the circumference of the head region is provided which exhibits at least one exit region.

20. The teat cup according to claim 13, characterised in that the exit region is formed on a front side of a duct extending substantially in the axial direction of the teat-cup liner.

21. The teat cup according to claim 13, characterised in that the duct or ducts is/are connected to at least one supply duct.

22. The teat cup according to claim 21, characterised in that at least two supply ducts are provided, through which differing fluids are capable of being supplied to the exit regions independently of one another.

23. The teat cup according to claim 13, characterised in that the teat-cup liner is of bipartite design.

24. The teat cup according claim 13, characterised in that the exit regions and/or the ducts are formed in and/or on the head region.

25. The teat cup according to claim 13, characterised in that the valve is arranged in a lower region, in particular in the end region or in the milk hose.

26. The teat cup according to claim 13, characterised in that the valve comprises at least one spray nozzle.

27. The teat cup according to claim 13, characterised in that the spray nozzle of the valve in the position closing the milk path is in the operating position.

28. The teat cup according to claim 13, characterised in that the valve exhibits at least one exit aperture for rinsing agents and/or disinfectants.

29. The teat cup according to claim 13, characterised in that the valve is a multi-way valve.

30. The teat cup according to claim 13, characterised in that a separate drainage line is provided for the foremilk.

31. The teat cup according to claim 13, characterised in that at least two separate drainage lines are provided for milk of differing quality.

32. The teat cup according to claim 13, characterised in that at least one feed for a rinsing liquid is provided which is preferably arranged at the valve.

33. The teat cup according to claim 13, characterised in that at least one feed for a disinfectant and/or grooming agent for application onto the teat is provided on the valve.

34. The teat cup according to claim 13, characterised in that at least one sensor device is provided, by means of which at least one parameter from a group of parameters which comprises a temperature, a conductance, a measure of the conductivity, a measure of the cell-count of the milk is capable of being determined.

35. The teat cup according to claim 13, characterised in that at least one combined sensor device is provided, by means of which at least a temperature and a measure of a conductivity of the milk are capable of being determined.

36. The teat cup according to claim 13, characterised in that a signal-transmission device is provided for the wireless transmission of signals.
